(19) United States
(12) Patent Application Publication
(10) Pub. No.: US 2006/0044224 A1
(43) Pub. Date: Mar. 2, 2006

(54) Display and method for driving a display

(76) Inventors: Su-Yong Chae, Suwon-si (KR); Hak-Cheol Yang, Suwon-si (KR)

Correspondence Address: MCGUIREWOODS, LLP, 1750 TYSONS BLVD, SUITE 1800, MCLEAN, VA, 22102, US

(21) Appl. No.: 11/061,482

(22) Filed: Feb. 22, 2005

(30) Foreign Application Priority Data
Aug. 30, 2004 (KR) 10-2004-0068549

(51) Int. Cl. G09G 3/28

(52) U.S. Cl. 345/63

(57) ABSTRACT

A display and driving method for a display applying a dithering process. The display includes a display panel, a controller, a first driver, and a second driver. The dithering process is applied in subfields of the display panel. A plurality of row electrodes is divided into a plurality of groups according to a dithering pattern in a subfield to which the dithering process is applied. Scan pulses are applied to row electrodes of a group out of the plurality of the groups in sequence, and scan pulses are applied to row electrodes of another group in sequence.

### CROSS REFERENCE TO RELATED APPLICATION

This application claims priority to and the benefit of Korean Patent Application No. 10-2004-0068549, filed on Aug. 30, 2004, which is hereby incorporated by reference for all purposes as if fully set forth herein.

### BACKGROUND OF THE INVENTION

1. Field of the Invention

The present invention relates to a display and driving method thereof. More specifically, the present invention relates to a display and method for driving a display that reduces power consumption when applying a dithering process.

2. Discussion of the Background

A plasma display panel (PDP) is a flat panel display that shows characters or images using plasma generated by gas discharge. In the PDP, a plurality of pixels (discharge is cells) is arranged in a matrix, and the pixels are selectively lit to display images. Accordingly, PDP pixel gray scales may be determined by the time each pixel emits light, and one TV field may be divided into a plurality of weighted subfields for driving the PDP. The time that a pixel emits light in corresponding subfields is determined by the subfield's weight, and the gray scales are represented by a combination of subfields, out of the plurality of subfields, in which the pixel emits light.

An address period is provided in each subfield to select pixels that will emit light for the subfield. In the address period, scan pulses may be sequentially applied to row electrodes, and an address pulse may be applied to a column electrode passing through a pixel formed on the row electrode to which a scan pulse is respectively applied, thereby selecting that pixel. A predetermined length of the address period is necessary to sequentially scan the row electrodes, and a period of one TV field (16.67 ms for NTSC) is also predetermined. Hence, the number of subfields that may be assigned to one TV field is limited. Therefore, gray scale levels that may be represented in the PDP are also limited. Consequently, a dithering process may be performed to represent more detailed gray scales.

The dithering process converts data of each cell by using a dithering pattern with a predetermined rule. Emission/non-emission patterns of neighboring pixels may be changed according to the dithering pattern's rule. A pixel among four pixels in a subfield for representing a gray scale 1 emits light while the other three pixels do not emit light when ¼ gray scales are represented by applying a 2×2 dithering pattern to four neighboring pixels. An address pulse is applied to the selected pixel but not to the other three pixels. However, power loss due to a switching operation may be caused because the switching operation interrupts application of the address pulse to the other pixel when the address pulse is applied to a pixel among two neighboring pixels. Since a naturally formed capacitance exists between the row electrodes and the column electrodes, power consumption increases because a voltage change generated in the address pulse consumes inactive power.

### SUMMARY OF THE INVENTION

The present invention provides a display and a method for driving a display with reduced power consumption when applying a dithering process.

The present invention varies an order for scanning in an address period of a subfield in which a dithering process is applied.

Additional features of the invention will be set forth in the description which follows, and in part will be apparent from the description, or may be learned by practice of the invention.

The present invention discloses a display including a display panel, a controller, a first driver, and a second driver. The display panel includes a plurality of row electrodes, a plurality of column electrodes crossing the row electrodes, and a plurality of cells respectively given by the row electrodes and the column electrodes. The controller divides a field into a plurality of subfields, and generates a control signal that controls driving the row electrodes and the column electrodes. The first driver selectively applies scan pulses to the row electrodes in an address period of each subfield, and the second driver applies address pulses in the address period to the column electrodes of a cell to be emitted. The controller determines a subfield to which a dithering process is applied according to the image data, divides the row electrodes into a plurality of groups according to the dithering pattern of the dithering process in the subfield to which the dithering process is applied from among a plurality of subfields, and the first driver selectively applies the scan pulses to row electrodes of a group, and then selectively applies the scan pulses to row electrodes of another group.

The present invention also discloses a method for driving a display including a plurality of row electrodes, a plurality of column electrodes crossing the row electrodes, and a plurality of cells respectively given by the row electrodes and the column electrodes, and a field has a plurality of subfields having respective weights. According to a driving method of the present invention, a subfield to which a dithering process is applied and a dithering pattern applied in the subfield are determined, and an order for scanning the row electrodes in the subfield to which the dithering pattern is applied is determined according to the dithering pattern. Scan pulses are selectively applied to the row electrodes according to the scanning order determined by the dithering pattern in the subfield to which the dithering pattern is applied.

The present invention also discloses a method for driving a display according to the present invention, where the image data are converted into subfield data for representing emission/non-emission status in the subfields. A cell to be emitted is selected out of the cells according to the subfield data in each subfield and the selected cell is emitted for a period corresponding to the weight of the subfield. In subfields in which an emission pattern is repeated with a predetermined rule in the column electrode direction, the row electrodes are grouped according to the predetermined rule, the cell to be emitted in row electrodes of a group is selected, and the cell to be emitted in row electrodes of another group is selected.

The present invention also discloses a display including a display panel, a controller, and a driver. The display panel includes a plurality of row electrodes, a plurality of column electrodes crossing the row electrodes, and a plurality of cells respectively given by the row electrodes and the column electrodes. The controller divides a field into a plurality of subfields having respective weights, generates a control signal that controls driving the row electrodes and the column electrodes from image data, and determines a subfield to which a dithering process is applied according to the image data. The driver selectively applies scan pulses to the plurality of the row electrodes of each subfield and applies address pulses to the column electrodes of a cell to be emitted out of cells formed on the row electrodes to which the scan pulses are applied. The controller applies a dithering pattern to data corresponding to the cells, the scan pulses are selectively applied to a plurality of row electrodes to which a first dither coefficient of the dithering pattern is applied, and the scan pulses are applied to a plurality of row electrodes to which a second dither coefficient of the dithering pattern is applied.

In a similar embodiment as just discussed, the controller establishes an order for applying the scan pulses to the row electrodes in the subfield to which the dithering process is applied to be different from an order for applying the scan pulses to the plurality of the row electrodes in a subfield to which no dithering process is applied.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic diagram showing a plasma display according to an exemplary embodiment of the present invention.

FIG. 2 is a diagram showing an example of a field divided into a plurality of subfields.

FIG. 3 is a diagram showing an address selecting circuit coupled to an address electrode.

FIG. 4 is a block diagram showing a part of a controller of FIG. 1.

FIG. 5 is a block diagram showing a dithering unit according to a first exemplary embodiment of the present invention.

FIG. 6A, FIG. 6B, FIG. 6C and FIG. 6D are diagrams showing respective dithering patterns of a dithering unit of FIG. 5.

FIG. 7A, FIG. 9A, and FIG. 10A are diagrams showing emission patterns when the dithering patterns of FIG. 6B, FIG. 6C, and FIG. 6D are applied, respectively.

FIG. 7B, FIG. 9B, and FIG. 10B are diagrams of a method for applying address pulses for emission patterns of FIG. 7A, FIG. 9A, and FIG. 10A, respectively, according to the prior art.

FIG. 7C, FIG. 9C, and FIG. 10C are diagrams of a method for applying address pulses for emission patterns of FIG. 7A, FIG. 9A, and FIG. 10A according to the first exemplary embodiment of the present invention.

FIG. 8 and FIG. 12 are diagrams showing a scanning method in an address period according to the first and second exemplary embodiments of the present invention.

FIG. 11 is a diagram showing a regularity of a 2^{k}×2^{k} dithering pattern.

### DETAILED DESCRIPTION OF THE ILLUSTRATED EMBODIMENTS

The following detailed description shows and describes exemplary embodiments of the invention, simply by way of illustration of the best mode contemplated by the inventors of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

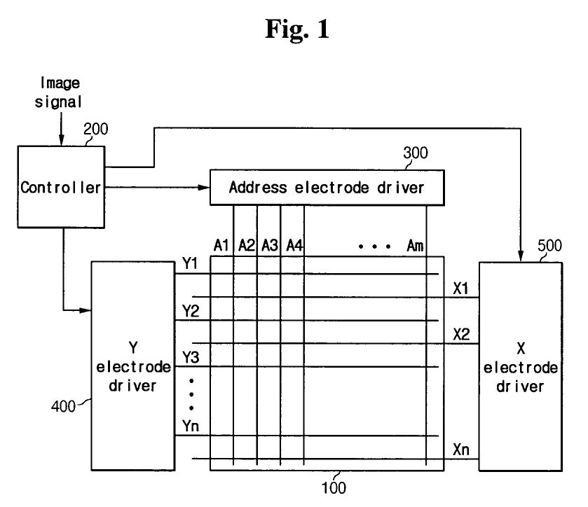

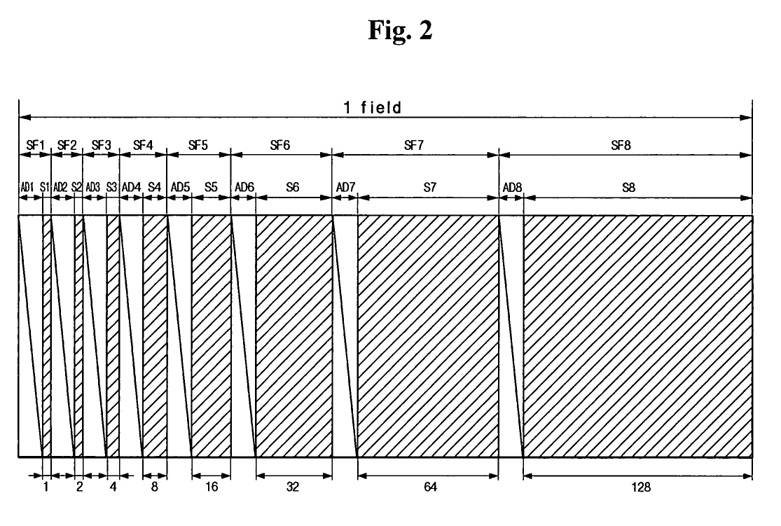

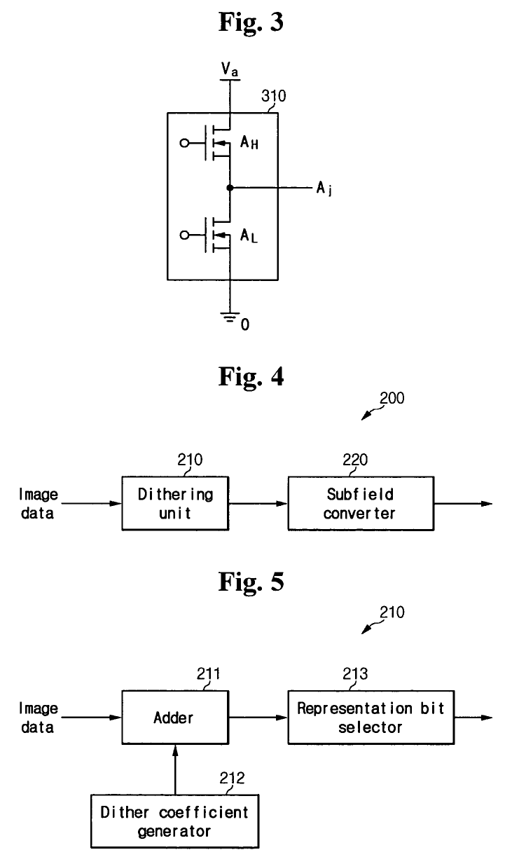

FIG. 1 is a schematic diagram showing a plasma display according to an exemplary embodiment of the present invention, and FIG. 2 is a diagram showing an example of a field divided into a plurality of subfields. FIG. 3 is a diagram showing an address selecting circuit coupled to an address electrode, and FIG. 4 is a block diagram showing a part of a controller of FIG. 1.

As shown in FIG. 1, a plasma display includes a PDP 100, a controller 200, an address electrode driver 300, an X electrode driver 400, and a Y electrode driver 500.

The PDP 100 includes a plurality of row electrodes for performing a scan function and a display function, and a plurality of column electrodes for performing an address function. In FIG. 1, the column electrodes are address electrodes A₁ to Aₘ (A electrodes), and the row electrodes are X electrodes X₁ to Xₙ and Y electrodes Y₁ to Yₙ arranged in pairs. A portion of a discharge space where an address electrode crosses an X and Y electrode pair defines a discharge cell (cell).

The controller 200 receives image signals and outputs address, sustain, and scan electrode driving control signals, and divides a field (normally corresponding to a frame) into a plurality of weighted subfields SF1 to SF8. The subfields SF1 to SF8 have address periods AD₁ to AD₈ in which a cell to be emitted is selected, and sustain periods S₁ to S₈ in which the selected cell is sustain-discharged for a period corresponding to a weight of the subfield. The subfields may have a reset period for re-setting charge states of of a cell.

In the address period, the Y electrode driver 400 applies scan pulses having scan voltages to the Y electrodes Y₁ to Yₙ in the order in which they are selected, and the address electrode driver 300 applies address pulses having address voltages to the A electrodes when the scan pulses are applied to the Y electrodes in order to select a cell. At this time, if a cell is not to be selected, a non-address voltage (normally the ground voltage) is applied to the A electrode. Therefore, simultaneously applying a scan and address pulse to a Y and A electrode, respectively, selects the corresponding cell to emit light in the subsequent sustain period.

As shown in FIG. 3, the address electrode driver 300 includes a plurality of address selecting circuits 310 coupled to a plurality of the address electrodes A₁ to Aₘ, respectively. FIG. 3 shows an address selecting circuit 310 coupled to a j^{th} address electrode A^{j}. The address selecting circuit 310 includes a switch A^{H} coupled between a power for supplying the address voltage V^{a} and the address electrode A^{j}, and a switch A^{L} coupled between the non-address voltage 0V and the address electrode A^{j}. The switches A^{H} and A^{L} are shown as negative-channel metal oxide semiconductor (NMOS) transistors, however, the present invention is not limited thereto. In the address selecting circuit 310, the address pulse Va is applied to the address electrode A^{j} when the switch A^{H} is turned on, and the non-address voltage of 0V is applied to the address electrode A^{j} when the switch A^{L} is turned on.

In the sustain period, the X electrode driver 500 and the Y electrode driver 400 alternately apply sustain discharging pulses to the X electrodes X¹ to Xⁿ and the Y electrodes Yⁱ to Yⁿ, respectively. A subfield's weight determines the number of the sustain discharging pulses, and the number sustain discharging pulses in a selected cell determines the number of sustain discharges.

As shown in FIG. 4, the controller 200 includes a dithering unit 210 and a subfield converter 220. The controller 200 may further include an inverse gamma corrector for performing inverse gamma correction on input image data. The dithering unit 210 performs a dithering process on the input image data or some bits of the image data corrected by the inverse gamma corrector by using a dithering pattern. The subfield converter 220 generates subfield data by mapping the dithered image data into a plurality of subfields, and determines the addressing method of each subfield according to results of the dithering process. For example, after applying the dithering process to a subfield, the subfield converter 220 may determine an addressing operation for odd row electrodes and then even row electrodes.

The subfield data generated by the subfield converter 220 correspond to whether the corresponding cell is to be lit in each subfield. As shown in FIG. 2, one field may be divided into 8 subfields SF1 to SF8 having respective weights of 2⁰, 2¹, 2², 2³, 2⁴, 2⁵, 2⁶ and 2⁷ for the purpose of representing 256 levels of gray scales. Therefore, subfield data corresponding to image data of a gray scale of 139 may be represented as 10001011 when arranged in reverse order of the subfield arrangement shown in FIG. 2. When applying the scan pulse to the Y electrode of the cell in subfields SF1, SF2, SF4, and SF8 corresponding to data of ‘1’, the address pulse is applied to the A electrode of the cell, and the cell is selected to be emitted. On the other hand, the non-address voltage is applied to the A electrode when applying the scan pulse to the Y electrode of the cell in subfields SF3 and SF5, SF6 and SF7, corresponding to data of ‘0’.

The dithering process in the controller 200 will be described referring to an example in which 10 bit image data is input to the dithering unit 210 when the gray scales of 8 bits (256 levels) are represented with a plurality of subfields.

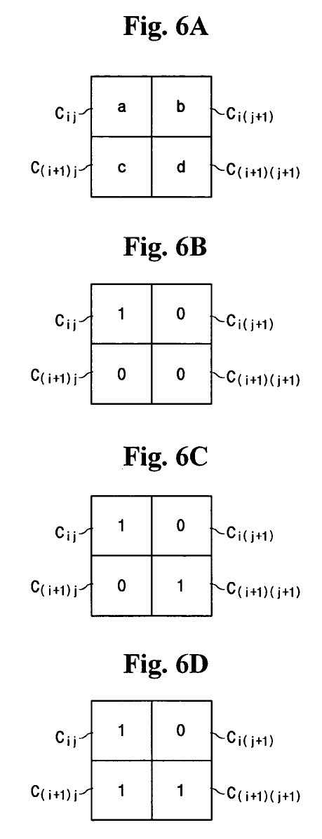

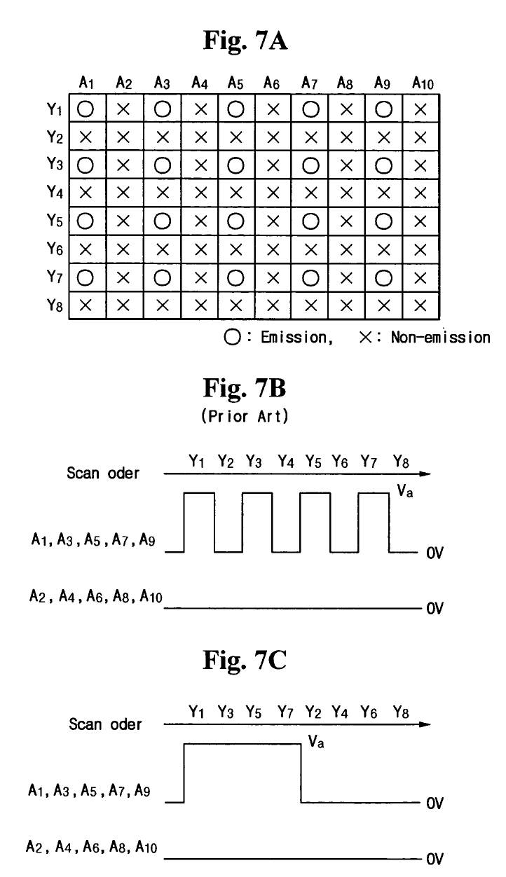

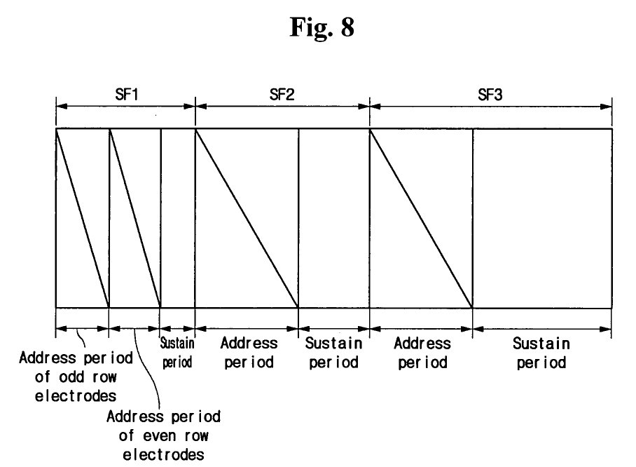

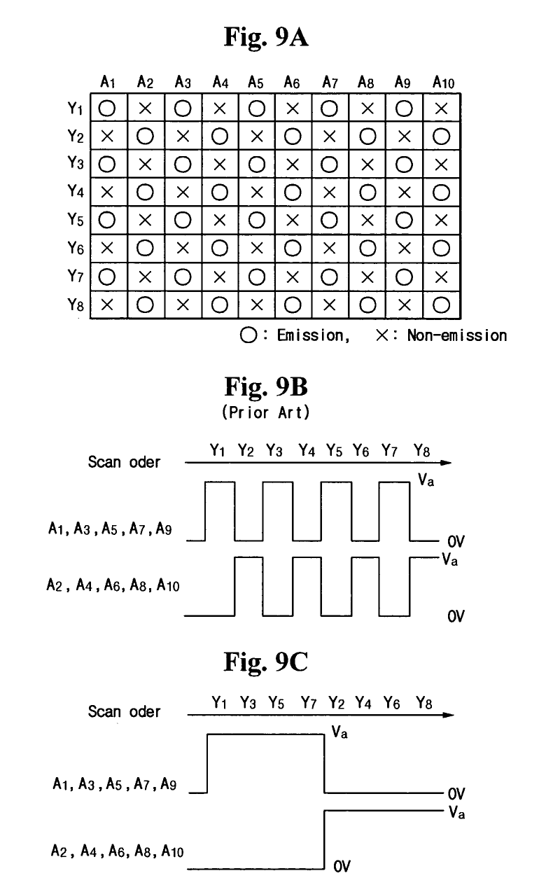

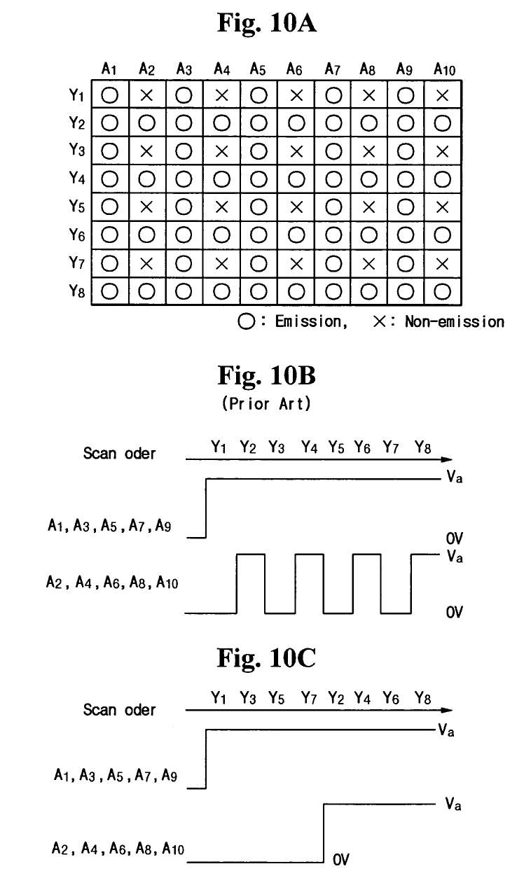

FIG. 5 is a block diagram showing a dithering unit 210 according to a first exemplary embodiment of the present invention, and FIG. 6A, FIG. 6B, FIG. 6C and FIG. 6D are diagrams showing dithering patterns of the dithering unit 210 of FIG. 5. FIG. 7A, FIG. 9A, and FIG. 10A are diagrams showing emission patterns when applying dithering patterns of FIG. 6B, FIG. 6C, and FIG. 6D, respectively. FIG. 7B, FIG. 9B, and FIG. 10B are diagrams showing a conventional method for applying address pulses in the emission patterns of FIG. 7A, FIG. 9A, and FIG. 10A, respectively. FIG. 7C, FIG. 9C, and FIG. 10C are diagrams showing a method for applying address pulses in the emission patterns of FIG. 7A, FIG. 9A, and FIG. 10A, respectively, according to a first exemplary embodiment of the present invention. FIG. 8 is a diagram showing a scanning method in an address period according to the first exemplary embodiment of the present invention.

As shown in FIG. 5, the dithering unit 210 includes an adder 211, a dither coefficient generator 212, and a representation bit selector 213. The dither coefficient generator 212 generates a dither coefficient according to the image data of the 2 least significant bits and transmits it to the adder 211. The adder 211 adds the dither coefficient to 10-bit image data. The representation bit selector 213 selects image data of the 8 most significant bits from the 10-bit image data output from the adder 211.

When using a 2×2 pattern as shown in FIG. 6A, FIG. 6B, FIG. 6C and FIG. 6D, the dither coefficient generator 212 generates the dither coefficients a, b, c, and d as a group of four cells which are neighboring each other vertically and horizontally. For example, as shown in FIG. 6A, the dither coefficient generator 212 establishes an i^{th} row and j^{th} column cell C^{ij}, an i^{th} row and (j+i)^{th} column cell C^{i(j+i)}, an (i+1)^{th} row and j^{th} column cell C^{(i+1)j}, and an (i+1)^{th} row and (j+1)^{th} column cell C^{(i+1)(j+1)} as a group, and generates the dither coefficients a, b, c, and d to correspond to the cells C^{ij}, C^{i(j+1)}, C^{(i+1)j}, and C^{(i+1)(j+1)}, respectively. The dither coefficient “a” is added to image data of the i^{th} row and j^{th} column cell C^{ij}, the dither coefficient “b” is added to image data of the i^{th} row and (j+1)^{th} column cell C^{i(j+1)}, the dither coefficient “c” is added to image data of the (i+1)^{th} row and j^{th} column cell C^{(i+1)j}, and the dither coefficient “d” is added to image data of the (i+1)^{th} row and (j+1)^{th} column cell C^{(i+1)(j+1)}.

The dither coefficients a, b, c, and d, which are generated to represent the gray scales corresponding to the 2 least significant bits, are values corresponding to the 8^{th} least significant bit from the 8 most significant bits. That is, the dither coefficient 1 is a value corresponding to “100”, and the dither coefficient 0 is a value corresponding to “000”. For example, as shown in FIG. 6B, when the two least significant bits are “01”, the dither coefficients a, b, c, and d may be 1, 0, 0, and 0, respectively, and average gray scales of the four cells are established to be “01”. When the two least significant bits are “10”, as shown in FIG. 6C, the dither coefficients a, b, c, and d may be 1, 0, 0, and 1, respectively, and the average gray scales of the four cells are established to be “10”. When the two least significant bits are “11”, as shown in FIG. 6D, the dither coefficients a, b, c, and d may be 1, 0, 1, and 1, respectively, and the average gray scales of the four cells are established to be “11”.

As shown in the dithering patterns of FIG. 6B, FIG. 6C and FIG. 6D, different dither coefficients of cells may be formed on the same A electrodes (column electrodes). In FIG. 6B, the dither coefficients a and c of the two cells C^{ij} and C^{(i+1)j} differ. In FIG. 6C, the dither coefficients a and c of the two cells C^{ij} and C^{(i+1)j}, and the dither coefficients b and d of the two cells C^{i(j+1)} and C^{(i+1)(j+1)} differ. In FIG. 6D, the dither coefficients b and d of the two cells C^{i(j+1)} and C^{(i+1)(j+1)} differ. However, image data of neighboring cells may have similar values, and therefore a value of an 8^{th} bit among the image data of the four cells C^{ij} is, C^{i(j+1)}, C^{(i+1)j}, and C^{(i+1)(j+1)} selected by the representation bit selector 213 may vary.

A value of the 8^{th} least significant bit among the 8-bit data output by the representation bit selector 213 varies when applying the dithering pattern of FIG. 6B when the 8 most significant bits of the image data of the four cells C^{ij}, C^{i(j+1)}, C^{(i+1)j}, and C^{(i+1)(j+1)} are the same. Accordingly, data of a minimum weight subfield SF1 may be varied out of the subfield data of the two cells C^{ij}, C^{i(j+1)} output by the subfield converter 220.

For example, when representing ¼ gray scales (“0000000001”), the 2×2 dithering pattern shown in FIG. 6B is applied, and FIG. 7A shows an emission pattern of the minimum weight subfield SF1. That is, subfield data ‘1’ and ‘0’ of the cells formed on the odd A electrodes A₁, A₃, A₅, A₇, and A₉ repeats in the column direction, and subfield data of the cells formed on the even A electrodes A₂, A₄, A₆, A₈, and A₁₀ is ‘0’.

A switch A_{L} of the address selecting circuit 310 of FIG. 3, coupled to the even A electrodes A₂, A₄, A₆, A₈, and A₁₀, turns on when applying the scan pulses to the Y electrodes in the address period of the subfield SF1. When applying the scan pulses to the odd Y electrodes Y₁, Y₃, Y₅ and Y₇, a switch A_{H} turns on and a switch A_{L} turns off in the address selecting circuit 310 coupled to the odd A electrodes A₁, A₃, A₅, A₇, and A₉. When applying the scan pulses to the even Y electrodes Y₂, Y₄, Y₆ and Y₈, the switch A_{H} turns off and the switch A_{L} turns on. Accordingly, when applying the scan pulses to the Y electrodes in the order that they are arranged, pulses shown in FIG. 7B may be applied to the A electrodes A₁ to A₁₀ to thus repeat on/off operations of the switches A_{H} and A_{L} in the odd address selecting circuit 310, thereby generating power loss according to the switching operations. Also, when voltages of the A electrodes A₁ to A₁₀ decrease from the address voltage Vₐ to a ground voltage 0V or increase from the ground voltage 0V to the address voltage Vₐ, inactive power may be consumed because a panel coupled to the A electrodes A₁ to A₁₀ operates as a capacitor. For example, with an area having 10 cells in the row direction and 8 cells in the column direction as shown in FIG. 7A, eight switching operations may be performed on the odd A electrodes A₁, A₃, A₅, A₇, and A₉ in the column direction, and Equation 1 gives the inactive power loss P₂₁.

$${P}_{21} = \frac{1}{2} {C}_{p} {V}_{a}^{2} \times 8 \times 5 = 20 {C}_{p} {V}_{a}^{2} \qquad [ EQUATION 1 ]$$

where C_{P} denotes capacitance formed on a panel coupled to the A electrodes.

Accordingly, in a first exemplary embodiment of the present invention, as shown in FIG. 8, in the subfield SF1 applying the dithering pattern, the odd Y electrodes Y₁, Y₃, Y₅ and Y₇ are scanned, and then the even Y electrodes Y₂, Y₄, Y₆ and Y₈ are scanned. That is, in FIG. 7A, the scan pulses may be sequentially applied to the odd Y electrodes Y₁, Y₃, Y₅ and Y₇, and then the scan pulses may be sequentially applied to the even electrodes Y₂, Y₄, Y₆ and Y₈. FIG. 7C shows a pulse that may be applied to the A electrodes A₁ to A₁₀ according to an exemplary embodiment of the present invention. Alternatively, it is possible to scan the even Y electrodes Y₂, Y₄, Y₆ and Y₈ and then scan the odd Y electrodes Y₁, Y₃, Y₅ and Y₇. The subfield data of the odd A electrodes A₁, A₃, A₅, A₇, and A₉ is 1 while applying the scan pulses to the odd Y electrodes Y₁, Y₃, Y₅ and Y₇ and 0 while applying the scan pulses to the even Y electrodes Y₂, Y₄, Y₆ and Y₈. Therefore, a switching power loss and an inactive power loss may be avoided. That is, the switching power loss and the inactive power loss may not be generated when scanning the even Y electrodes after the odd Y electrodes.

When representing the 2/4 gray scale “0000000010”, FIG. 9A shows the emission pattern of the minimum weight subfield SF1 when applying the dithering pattern shown in FIG. 6C. That is, subfield data ‘1’ and ‘0’ of the cells formed on the odd A electrodes A₁, A₃, A₅, A₇, and A₉ repeat in the column direction, and subfield data ‘0’ and ‘1’ of the cells formed on the even A electrodes A₂, A₄, A₆, A₈, and A₁₀ repeat in the column direction.

FIG. 9B shows a conventional pulse that may be applied to the A electrodes A₁ to A₁₀, and applying the scan pulse to the Y electrodes in the order that they are arranged may generate a power loss and an inactive power loss caused by switching operations in the address selecting circuit 310. As shown in FIG. 9A, eight switching operations may be performed in the odd A electrodes A₁, A₃, A₅, A₇, and A₉ in the column direction, and eight switching operations may be performed in the even A electrodes A₂, A₄, A₆, A₈, and A₁₀ in the column direction. Hence, equation 2 gives the inactive power loss P₂₂.

$${P}_{22} = \frac{1}{2} {C}_{p} {V}_{a}^{2} \times 8 \times 10 = 40 {C}_{p} {V}_{a}^{2} \qquad [ EQUATION 2 ]$$

As shown in FIG. 8 and described above, in the subfield SF1 applying the dithering pattern, the odd Y electrodes Y₁, Y₃, Y₅ and Y₇ may be scanned, and then the even Y electrodes Y₂, Y₄, Y₆ and Y₈ may be scanned. FIG. 9C shows a pulse that may be applied to the A electrodes A₁ to A₁₀ in accordance with an exemplary embodiment of the present invention. While applying the scan pulse to the odd Y electrodes Y₁, Y₃, Y₅ and Y₇, a switching power loss and an inactive power loss may not be generated because the subfield data of the odd A electrodes A₁, A₃, A₅, A₇, and A₉ is 1, and the subfield data of the even A electrodes A₂, A₄, A₆, A₈, and A₁₀ is 0. Additionally, while applying the scan pulse to the even Y electrodes Y₂, Y₄, Y₆ and Y₈, a switching power loss and an inactive power loss may not be generated because the subfield data of the odd A electrodes A₁, A₃, A₅, A₇, and A₉ is 0, and the subfield data of the even A electrodes A₂, A₄, A₆, A₈, and A₁₀ is 1.

When representing the ¾ gray scale “0000000011”, FIG. 10A shows the emission pattern of the minimum weight subfield SF1 when applying the dithering pattern shown in FIG. 6D. That is, the subfield data of the cells formed on the odd A electrodes A₁, A₃, A₅, A₇, and A₉ is ‘1’, and subfield data of ‘0’ and ‘1’ of the cells formed on the even A electrodes A₂, A₄, A₆, A₈, and A₁₀ repeat in the column direction.

FIG. 10B shows a conventional pulse that may be applied to the A electrodes A₁ to A₁₀, and applying the scan pulse to the Y electrodes in the order that they are arranged may generate a power loss and an inactive power loss according to the switching operations in the address selecting circuit 310. As shown in FIG. 10A, eight switching operations may be performed in the even A electrodes A₂, A₄, A₆, A₈, and A₁₀ in the column direction, and two switching operations may be performed in the odd A electrodes A₁, A₃, A₅, A₇, and A₉ in the column direction. Hence, equation 3 gives the inactive power loss P₂₃.

$${P}_{23} = ( \frac{1}{2} {C}_{p} {V}_{a}^{2} \times 2 + \frac{1}{2} {C}_{p} {V}_{a}^{2} \times 8 ) \times 5 = 25 {C}_{p} {V}_{a}^{2} \qquad [ EQUATION 3 ]$$

As shown in FIG. 8 and described above, in the subfield SF1 applying the dithering pattern, the odd Y electrodes Y₁, Y₃, Y₅ and Y₇ may be scanned, and then the even Y electrodes Y₂, Y₄, Y₆ and Y₈ may be scanned. FIG. 10C shows a pulse that may be applied to the A electrodes A₁ to A₁₀ in accordance with an exemplary embodiment of the present invention. Applying the scan pulse to the odd Y electrodes Y₁, Y₃, Y₅ and Y₇ may not generate a switching power loss and an inactive power loss because the subfield data of the even A electrodes A₂, A₄, A₆, A₈, and A₁₀ is 0. Additionally, applying the scan pulse to the even Y electrodes Y₂, Y₄, Y₆ and Y₈ may not generate a switching power loss and an inactive power loss because the subfield data of the even A electrodes A₂, A₄, A₆, A₈, and A₁₀ is 1.

As discussed above, ¼, 2/4 and ¾ gray scales may be represented on a full screen. Scanning the Y electrodes in the order that they are arranged may generate a switching power loss and an inactive power loss because the patterns shown in FIG. 6B, FIG. 6C and FIG. 6D may normally be selectively applied. In the subfield applying the dithering pattern, scanning the odd Y electrodes and then the even Y electrodes, or scanning the even Y electrodes and then the odd Y electrodes, may reduce power loss, as described in the first exemplary embodiment of the present invention. While a 2×2 dithering pattern has been described above, the present invention is also applicable to a N×N dithering pattern, where N is an integer that is greater than or equal to 3. For example, when using a 3×3 dithering pattern, the Y electrodes may be divided into a first group having (3i-2)^{th} Y electrodes Y₁, Y₄, Y₇, . . . and Y₍₃ᵢ₋₂₎, a second group having (3i-1)^{th} Y electrodes Y₂, Y₅, Y₈, . . . and Y₍₃ᵢ₋₁₎, and a third group having 3i^{th} Y electrodes Y₃, Y₆, Y₉, . . . and Y₃ᵢ. In this case, the Y electrodes of the first group, the second group, or the third group may be selectively scanned, then Y electrodes of a remaining group may be scanned, and then Y electrodes of the final group may be scanned.

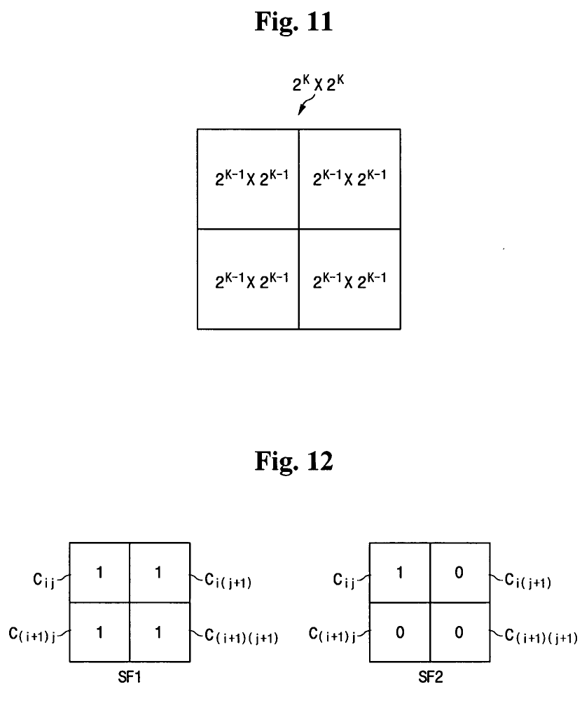

Conventionally, the dithering pattern is formed with a 2^{k}×2^{k} pattern, and the 2^{k}×2^{k} pattern may be formed with four 2^{k-1}×2^{k-1} patterns respectively having similar patterns as shown in FIG. 11. The 2^{k}×2^{k} dithering pattern is accordingly formed with a plurality of 2×2 dithering patterns respectively having similar patterns, and therefore the power consumption is reduced in the 2^{k}×2^{k} dithering pattern when the row electrodes are grouped in order to reduce the power consumption in the 2×2 dithering pattern.

It has been described that predetermined bits are selected to generate the subfield data when the dither coefficient is added to the input image data in the first exemplary embodiment of the present invention. However, the dither coefficient may be added to the subfield data of the subfield for applying the dithering process when the subfield data is generated. Also, the dither coefficients may be differently placed according to frames in the dithering pattern. For example, the dither coefficients may be rotated to be placed in the predetermined direction for each frame or for a predetermined number of frames.

In the first exemplary embodiment of the present invention, the least significant bit of the input image data is dithered, and the dithering pattern is applied to the subfield SF1 having a minimum weight. The dithering pattern may also be applied to other subfields besides the subfield SF1, and the row electrodes may be grouped according to the scanning order in the subfield applying the dithering pattern, which will be described with reference to FIG. 12.

FIG. 12 shows a scanning method in an address period according to a second exemplary embodiment of the present invention.

The dithering method may be used to represent a gray scale of 2 when a weight of the subfield SF1 having a minimum weight is 1, and a weight of the subfield SF2 having a next lowest weight is 4. The value of ‘1’ may be assigned to the first subfield SF1 of the four neighboring cells C^{ij}, C^{i(j+1)}, C^{(i+1)j}, and C^{(i+1)(j+1)}, and the dithering pattern as shown in FIG. 6B may be applied to the second subfield SF2. The gray scale of 2 may be represented by an average of the gray scales of the four cells C^{ij}, C^{i(j+1)}, C^{(i+1)j}, and C^{(i+1)(j+1)}. Accordingly, in the second subfield SF2, the group having the odd row electrodes may be scanned, and then the group having the even row electrodes may be scanned, to reduce the power loss caused by the dithering pattern.

As described above, the present invention may be applied to the subfields applying the dithering process to represent the gray scales, and the row electrodes may be grouped according to the dithering patterns applied in the respective subfields. The row electrodes of a group are selectively (e.g., in sequence) scanned, and then the row electrodes of another group are scanned. That is, the row electrodes having corresponding dither coefficients may be established to be the same group according to the dither coefficient to which the dithering pattern is applied.

The dithering pattern may be applied to neighboring cells for each color and physically neighboring cells when a color is represented by cells of red R, green G, and blue B.

The plasma display has been exemplified in the exemplary embodiments of the present invention, but the present invention is not limited thereto.

According to exemplary embodiments of the present invention, row electrodes having corresponding dither coefficients may be established to be the same group according to the dither coefficient to which the dithering pattern is applied. The row electrodes. of a group are scanned, and then the row electrodes of another group are scanned, thereby preventing an increase of switching loss and inactive power caused by the dithering pattern.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display, comprising:
a display panel including a plurality of row electrodes, a plurality of column electrodes, and a plurality of cells defined by the row electrodes and the column electrodes;
a controller for dividing a field into a plurality of subfields and for generating a control signal that controls driving the row electrodes and the column electrodes;
a first driver for selectively applying scan pulses to the row electrodes in an address period of each subfield; and
a second driver for applying address pulses in the address period to the column electrodes of cells to be emitted,
wherein the controller determines a subfield to which a dithering process is applied, divides the row electrodes into a plurality of groups according to a dithering pattern of the dithering process in the subfield to which the dithering process is applied,
wherein the first driver applies the scan pulses to a group of row electrodes, and then applies the scan pulses to another group of row electrodes.

2. The display of claim 1, wherein the controller divides the row electrodes into a first group comprising odd row electrodes and a second group comprising even row electrodes when the dithering pattern is a 2ⁿ×2ⁿ pattern, where n is a natural number.

3. The display of claim 1, wherein the controller divides the row electrodes into N groups, and an i^{th} group of the N number groups is formed with an (Nj−(N−i))^{th} row electrode, where N is an integer greater than 2 and where j is a natural number.

4. The display of claim 1, wherein the controller applies the dithering process to a subfield having a minimum weight among the subfields.

5. The display of claim 1, wherein the controller groups the row electrodes according to the dithering pattern in a subfield to which the dithering process is applied.

6. The display of claim 1, wherein the row electrodes comprise a first electrode and a second electrode in pairs, and the scan pulses are applied to the first electrode.

7. The display of claim 6, wherein sustain discharging pulses are alternately applied to the first electrodes and the second electrodes.

8. A method for driving a display comprising a plurality of row electrodes, a plurality of column electrodes, and a plurality of cells defined by the row electrodes and the column electrodes, and having a field formed with a plurality of subfields, the method comprising:
determining a subfield to which a dithering process is applied according to image data, and a dithering pattern applied in the subfield;
determining an order for scanning the row electrodes according to the dithering pattern in the subfield to which the dithering pattern is applied; and
applying scan pulses to the row electrodes according to the scanning order.

9. The method of claim 8, wherein the row electrodes are divided into a plurality of groups according to the dithering pattern, and row electrodes of a group are scanned, and then row electrodes of another group are scanned.

10. The method of claim 9, wherein the row electrodes are divided into a first group comprising odd row electrodes and a second group comprising even row electrodes when the dithering pattern is a 2ⁿ×2ⁿ pattern, where n is a natural number.

11. The method of claim 9, wherein the row electrodes are divided into N groups, and an i^{th} group out of the N groups is formed with an (Nj−(N−i))^{th} row electrode, where N is an integer greater than 2 and where j is a natural number.

12. A method for driving a display comprising a plurality of row electrodes, a plurality of column electrodes, and a plurality of cells respectively given by the row electrodes and the column electrodes, and having a plurality of subfields in which each field has a weight, the method comprising:
converting the image data into subfield data for representing a status of emission/non-emission in the subfields; and
selecting a cell to be emitted according to the subfield data in each subfield, and emitting the selected cell for a period corresponding to the weight of the subfield,
wherein the row electrodes are grouped according to a predetermined rule, a cell to be emitted in a group of row electrodes is selected, and a cell to be emitted in another group of row electrodes is selected in subfields in which an emission pattern is repeated with the predetermined rule in a column electrode direction.

13. The method of claim 12, wherein the predetermined rule is determined by a dithering pattern applied to a dithering process.

14. The method of claim 13, wherein the row electrodes are divided into a first group comprising odd row electrodes and a second group comprising even row electrodes when the dithering pattern is a 2ⁿ×2ⁿ pattern, where n is a natural number.

15. The method of claim 13, wherein the plurality of the row electrodes are divided into N groups, and an i^{th} group out of the N groups is formed with an (Nj−(N−i))^{th} row electrode, where N is an integer greater than 2 and where j is a natural number.

16. A display, comprising:
a display panel including a plurality of row electrodes, a plurality of column electrodes crossing the row electrodes, and a plurality of cells respectively given by the row electrodes and the column electrodes;
a controller for dividing a field into a plurality of subfields having respective weights, generating a control signal that controls driving the row electrodes and the column electrodes, determining a subfield to which a dithering process is applied according to image data; and
a driver for applying scan pulses to the row electrodes of each subfield, and applying address pulses to the column electrodes of a cell to be emitted out of cells formed on the row electrodes to which the scan pulses are applied,
wherein the controller establishes an order for applying the scan pulses to the row electrodes in a subfield to which the dithering process is applied to be different from an order for applying the scan pulses to the row electrodes in a subfield to which no dithering process is applied.

17. The display of claim 16, wherein in a subfield to which the dithering process is applied, the driver applies the scan pulses to row electrodes in which a first dither coefficient of a dithering pattern is applied, and then applies the scan pulses to row electrodes in which a second dither coefficient of the dithering pattern is applied.

18. The display of claim 17, wherein the first dither coefficient and the second dither coefficient are applied to two neighboring cells in the column direction.

19. The display of claim 17, wherein a value of the first dither coefficient and a value of the second dither coefficient differ.
